(19) United States
(12) Patent Application Publication
(10) Pub. No.: US 2014/0016691 A1
(43) Pub. Date: Jan. 16, 2014

(54) Adaptive Interference Suppression Using Interference Power Measurements

(71) Applicant: Rambus Inc., Sunnyvale, CA (US)

(72) Inventor: Aykut Bultan, Santa Clara, CA (US)

(21) Appl. No.: 13/942,438

(22) Filed: Jul. 15, 2013

Related U.S. Application Data
(60) Provisional application No. 61/672,245, filed on Jul. 16, 2012.

(51) Int. Cl. H04B 1/12; H04L 25/03

(52) U.S. Cl. CPC H04B 1/123; H04L 25/03885
USPC 375/232; 375/350

(57) ABSTRACT

Systems and methods are disclosed for interference suppression in a mobile device (MS). In certain embodiments, the MS uses handover measurements to detect and measure the interference powers of neighbor cells and sorts them with respect to their power levels. An RSRP ratio of serving cell RSRP to neighbor cell RSRP may be used to determine the interference power levels of the neighbor cells. Alternately, RSRQ may be used to determine the interference power levels of the neighbor cells. The MS may estimate the interference of each cell with an interference power level above a certain threshold and then subtract each interference estimate from the total received signal until all the selected interferers are suppressed. In certain embodiments, the interference suppressed signal may then be equalized and/or decoded. Equalization may occur during suppression of interference from individual neighbor cells or after all neighbor cell interference estimates have been subtracted.

This application claims priority to U.S. Provisional Patent Application No. 61/672,245, filed Jul. 16, 2012, which is hereby incorporated by reference herein in its entirety.

### BACKGROUND OF THE DISCLOSURE

1. The disclosure generally relates to systems and methods for suppressing interference in signals received by mobile stations, and more particularly for comparing RSRP ratio or RSRQ for neighbor cells to a threshold to determine which neighbor cell interference signals to suppress.

### 2. GENERAL BACKGROUND

In current wireless systems, the ratio of cell edge throughput versus peak throughput can pose issues. This ratio can easily be more than 100. Ideally, a ratio close to one is desirable. The peak throughput is generally obtained close to the Base Station (BS) under ideal conditions. As the Mobile Station (MS) moves further away from the BS, the throughput decreases due to propagation loss and increased interference from neighbor cells. Achieving homogeneous throughput distribution over time and space has not been achieved by conventional methods.

Interference Cancellation (IC) methods and algorithms are increasingly being used in the wireless systems both in the Downlink (DL) and the in the Uplink (UL) to cope with this problem. IC techniques can improve receiver performance but are limited by the accuracy of the interference estimate. If there is a significant error in interference estimation, then the IC algorithm can actually degrade rather than improve receiver performance.

It is desirable to address the limitations in the art.

### BRIEF DESCRIPTION OF THE DRAWINGS

By way of example, reference will now be made to the accompanying drawings.

FIG. 1 illustrates an interference suppressor in accordance with certain embodiments of the invention.

FIG. 2 illustrates a method for interference suppression in accordance with certain embodiments of the invention.

FIG. 3 illustrates another method for interference suppression in accordance with certain embodiments of the invention.

FIG. 4 illustrates another method for interference suppression in accordance with certain embodiments of the invention.

FIG. 5 illustrates another method for interference suppression in accordance with certain embodiments of the invention.

### DETAILED DESCRIPTION

Certain embodiments of methods and systems are disclosed for increasing the reliability of interference suppression techniques by using adaptive methods without significant increase in complexity.

In certain embodiments, a method is disclosed for suppressing interference comprising: determining a signal power of a serving cell; determining an interference power of each of one or more neighbor cells; constructing an interference estimate for each of the neighbor cells for which the ratio of signal power to interference power is less than a threshold; subtracting each of the interference estimates from a total received signal to generate an interference suppressed signal. The method may further comprise equalizing the interference suppressed signal to generate an equalized signal. The method may further comprise decoding the equalized signal to generate a decoded symbol. The method may further comprise sorting the neighbor cells from highest interference power to lowest interference power. Subtracting may comprise subtracting each of the interference estimates in order from highest interference power to lowest interference power. The signal power may equal the Reference Signal Received Power for the serving cell. The interference power of each neighbor cell may equal the Reference Signal Received Power for the neighbor cell. Constructing an interference estimate may comprise constructing an interference estimate at least in part from a pilot signal for each of the neighbor cells for which the signal to interference ratio is less than the threshold.

In certain embodiments, a method is disclosed for suppressing interference comprising: determining an interference power of each of one or more neighbor cells to a serving cell; comparing the interference power of each of the neighbor cells to a threshold; constructing an interference estimate for each of the neighbor cells for which the interference power exceeds the threshold; subtracting each of the interference estimates from a total received signal to generate an interference suppressed signal. The method may further comprise equalizing the interference suppressed signal to generate an equalized signal. The method may further comprise decoding symbol. The interference power of each neighbor cell may equal the Reference Signal Received Quality for the neighbor cell.

In certain embodiments, a method is disclosed for suppressing interference comprising: determining a Received Signal Received Power (RSRP) for each of n neighbor cells to a serving cell; sorting the RSRP for each of the n neighbor cells from a first largest RSRP to an nth smallest RSRP; setting an interference suppressed signal equal to the total received signal; for i=1 to n: determining an i^{th} RSRP ratio of a serving cell RSRP to the i^{th} RSRP; comparing the i^{th} RSRP ratio to a threshold; if the i^{th} RSRP ratio is less than the threshold: constructing an i^{th} interference estimate for the i^{th} neighbor cell; subtracting the i^{th} interference estimate from the interference suppressed signal to generate an i^{th} interference suppressed signal; setting the interference suppressed signal equal to the i^{th} interference suppressed signal; and incrementing i; and if the i^{th} RSRP ratio is greater than or equal to the threshold: equalizing the interference suppressed signal to form an equalized signal; and decoding the equalized signal to form a decoded symbol or signal. The i^{th} RSRP ratio may be determined at least in part from a pilot signal for the i^{th} neighbor cell.

In certain embodiments, a method is disclosed for suppressing interference comprising: determining an Received Signal Received Quality (RSRQ) for each of n neighbor cells to a serving cell; sorting the RSRQ for each of the n neighbor cells from a first largest RSRQ to an nth smallest RSRQ; setting an interference suppressed signal equal to the total received signal; for i=1 to n: comparing the i^{th} RSRQ to a threshold; if the i^{th} RSRQ is greater than the threshold: constructing a i^{th} interference estimate for the i^{th} neighbor cell; subtracting the i^{th} interference estimate from the interference suppressed signal to generate an i^{th} interference suppressed signal; setting the interference suppressed signal equal to the i^{th} interference suppressed signal; and incrementing i; and if the i^{th} RSRQ is less than or equal to the threshold: equalizing the interference suppressed signal to form an equalized signal; and decoding the equalized signal to form a decoded signal. The i^{th} RSRQ may be determined at least in part from a pilot signal for the i^{th} neighbor cell.

In certain embodiments, a method is disclosed for suppressing interference comprising: determining an Received Signal Received Power (RSRP) for each of n neighbor cells to a serving cell; sorting the RSRP for each of the n neighbor cells from a first largest RSRP to an nth smallest RSRP; setting an interference suppressed signal equal to the total received signal; for i=1 to n: determining an i^{th} RSRP ratio of a serving cell RSRP to the i^{th} RSRP; comparing the i^{th} RSRP ratio to a threshold; if the i^{th} RSRP ratio is less than the threshold: constructing an i^{th} interference estimate for the i^{th} neighbor cell; subtracting the i^{th} interference estimate from the interference suppressed signal to generate an i^{th} interference suppressed signal; equalizing the i^{th} interference suppressed signal to form an i^{th} equalized signal; setting the interference suppressed signal equal to the i^{th} equalized signal; incrementing i; and if the i^{th} RSRP ratio is greater than or equal to the threshold: decoding the interference suppressed signal to form a decoded signal. The i^{th} RSRP ratio may be determined at least in part from a pilot signal for the i^{th} neighbor cell.

In certain embodiments, a method is disclosed for suppressing interference comprising: determining a Received Signal Received Quality (RSRQ) for each of n neighbor cells to a serving cell; sorting the RSRQ for each of the n neighbor cells from a first largest RSRQ to an nth smallest RSRQ; setting an interference suppressed signal equal to the total received signal; for i=1 to n: comparing the i^{th} RSRQ to a threshold; if the i^{th} RSRQ is greater than the threshold: constructing an i^{th} interference estimate for the i^{th} neighbor cell; subtracting the i^{th} interference estimate from the interference suppressed signal to generate an i^{th} interference suppressed signal; equalizing the i^{th} interference suppressed signal to form an i^{th} equalized signal; setting the interference suppressed signal equal to the i^{th} equalized signal; setting i=i+1; and if the i^{th} RSRQ is less than or equal to the threshold: decoding the interference suppressed signal to form a decoded signal. The i^{th} RSRQ may be determined at least in part from a pilot signal for the i^{th} neighbor cell.

In certain embodiments, an interference suppressor is disclosed comprising: a receiver for receiving a total received signal and one or more signals from one or more neighbor cells; a channel estimator for generating channel estimates for the one or more neighbor cells; a power measurement unit for estimating powers of a serving cell and the one or more neighbor cells; a comparator for comparing each of the powers from the one or more neighbor cells with a threshold; an interference estimator for generating interference estimates for neighbor cells whose power exceeds the threshold; an interference suppressor for subtracting the interference estimates from the total received signal to generate an interference suppressed signal. The interference suppressor may further comprise a channel equalizer for equalizing the interference suppressed signal to generate an equalized signal. The interference suppressor may further comprise a channel decoder for decoding the equalized signal to form a decoded signal. The one or more signals may comprise one or more pilot signals from the one or more neighbor cells.

The method may also include equalizing the interference suppressed signal for wireless channel degradation to generate an equalized stream of received data symbols. The method may further comprise a symbol de-mapper to obtain the received information bits. The method may further comprise using a channel decoder to obtain the received data bits. The interference power of each neighbor cell may be measured by the Reference Signal Received Power (RSRP) for the neighbor cell.

In certain embodiments, a method is disclosed for suppressing interference comprising: determining an RSRP for each of n neighbor cells to a serving cell; sorting the RSRP for each of the n neighbor cells from a first largest RSRP to an nth smallest RSRP; setting an interference suppressed signal equal to the total received signal; for i=1 to n: determining an i^{th} RSRP ratio of a serving cell RSRP to the i^{th} RSRP; comparing the i^{th} RSRP ratio to a threshold; if the i^{th} RSRP ratio is less than the threshold: constructing an i^{th} interference estimate for the i^{th} neighbor cell; subtracting the i^{th} interference estimate from the interference suppressed signal to generate an i^{th} interference suppressed signal; setting the interference suppressed signal equal to the i^{th} interference suppressed signal; and incrementing i; and if the i^{th} RSRP ratio is greater than or equal to the threshold: equalizing the interference suppressed signal to form equalized data symbols; and decoding the equalized signal to form a decoded symbols The i^{th} RSRP ratio may be determined at least in part from a pilot signal for the i^{th} neighbor cell.

Interference Cancellation (IC) methods and algorithms are increasingly being used in the wireless systems both in the Downlink (DL) and the in the Uplink (UL). There are many different approaches in IC techniques like Serial Interference Cancellation (SIC), Parallel Interference Cancellation (PIC), Interference Rejection Combining (IRC), etc. Although IC techniques may significantly improve the receiver performance, this is only valid if the interference is estimated accurately. If there is a significant estimation error in interference estimates, then the IC algorithm reduce rather than improve performance. This error may originate from the channel estimation of the interference component.

The possibility of interference estimation error decreases and the benefits of interference suppression increase proportional to Signal to Interference Ratio (SIR). The accuracy of an interference suppression method depends on the power level of the interferer over the signal component and the particular interference suppression method that is being used. Therefore, signal power and interference power measurements can help to improve the accuracy of the interference suppression scheme. However, there measurements can also add complexity of the receiver. In order to improve accuracy without increasing complexity, the handover measurements of the Mobile Station (MS) can be used for interference suppression to achieve an improved interference suppression based receiver without increasing its complexity as compared to conventional designs.

To increase the reliability of interference suppression methods, neighbor cell power measurements may be used as a decision metric to adaptively turn interference suppression on and off with respect to a particular neighbor cell. For this purpose, the serving cell power is compared with the interfering cell powers of the neighbor cells. As the SIR level of the serving cell with respect to any of the neighbor cells goes below a threshold, the interference belonging to any one of those neighbor cell with strong interference is estimated and subtracted from the serving cell signal in the order from strongest to the lowest. The threshold may be predetermined or may be obtained experimentally.

For example, using a simple predetermined threshold around 12 dB can work for many cases. This means if the ratio of the measured power of the serving cell over the measured power of the interfering cell is below 12 dB, an interference suppression algorithm is applied. Otherwise, interference suppression is not applied to the received signal. To derive this threshold number experimentally a link level simulator may be used. This may consist of multiple Base Stations and multiple MS. In one example, one MS and BS pair is selected as the client and the serving cell. The interference from other BS is generated in the same simulator. Although not restricted to these cases, 3GPP mobility test cases as defined in 3GPP TS 36.133, LTE Evolved Universal Terrestrial Radio Access (E-UTRA); Requirements for support of radio resource management are being used to derive the tests. Monte Carlo simulations are run under these test cases and BER vs. SNR graphs are obtained for the MS with interference suppression and without interference suppression. These experiments may be repeated for different channel conditions and different threshold parameters to obtain a range of threshold values that outperforms the algorithms without thresholding. In one example, this is an pseudo exhaustive search with practical limitations. It is observed that a threshold values less than about 17 dB works most of the time.

In certain embodiments, adaptive thresholding techniques may be used in a mobile device or user equipment (UE) to determine the threshold. One way of adapting thresholding is having a look up table of threshold parameter values vs. the RSRP of the serving cell. The values in Table 1 summarize the result of such an approach. The similar results can be used for threshold parameters vs. RSSI as well. With this approach, the possibility of destructive interference suppression may be significantly reduced.

| RSRP (dBm) | Threshold (dB) |
|---|---|
| RSRP <−100 | ≦12 |
| −100 <RSRP <−90 | ≦15 |
| −90 <RSRP | ≦17 |

In certain embodiments, the received signal for an OFDM-MIMO system without interference can be modeled as shown in Equation 1 below:

Y(n,k)=H(n,k)X(n,k)+W(n,k) Equation 1

Here, H(n, k) is M×N channel matrix of the MIMO channel for each time and frequency indexes n and k, respectively. M represents the number of transmit antennas and N represents the number of receive antennas. Note that for LTE, k represents the subcarrier index, whereas n represents the OFDM symbol index. As the MS gets closer to the cell edge, interference from other cells becomes significant. Then the received signal can be modeled as shown in Equation 2 below:

Y(n,k)=H(n,k)X(n,k)+I(n,k)+W(n,k) Equation 2

In certain embodiments, the MIMO channel may be estimated using pilots. The receiver equalizer can then be used to suppress noise and interference. In certain embodiments, an MMSE equalizer can be used as shown in Equation 3 below:

$${X}_{est} ( n , k ) = {H}_{est}^{H} ( n , k ) {( {H}_{est} ( n , k ) {H}_{est}^{H} ( n , k ) + \frac{1}{SNR} I )}^{- 1} Y ( n , k ) \qquad Equation 3$$

Here Hₑₛₜ(n, k) is the estimated channel response matrix in time and frequency. This method may not be very efficient as the SNR decreases such as around cell edge. To increase the efficiency of the receiver equalization, an interference suppression algorithm may be performed prior to the equalization.

In certain embodiments, an interference suppression algorithm may require estimation of the interference. Most of the standards based wireless systems have some kind of channel sounding signals available, which may include without limitation pilot or reference signals.

For example, in OFDM-MIMO, the channel impulse response (CIR) of the interfering cell can be estimated using the pilots that belong to the interfering neighbor cell as shown in Equation 4 below:

Y(n,k)=H(n,k)X(n,k)+Hᵢ(n,k)Xᵢ(n,k)+W(n,k) Equation 4

Hᵢ(n, k) is an N×M MIMO channel matrix that corresponds to M transmit and N receive antennas for the interfering neighbor cell. In certain embodiments, neighbor cells might be detected though either cell selection or cell reselection.

In certain embodiments, neighbor cells may comprise those base stations physically proximate to the serving cell. In certain embodiments, neighbor cells may comprise a list of neighbor cells provided by the serving cell. In certain embodiments, neighbor cells may comprise a measured list of possible cells, which may be based on a search by the MS/UE. In certain embodiments, the serving cell BS may provide a list of neighbor cells which list may be narrowed down by the UE to form a narrowed list of neighbor cells.

For the purposes of this application, the term cell shall include without limitation a multi-cell which may comprises a plurality of cooperative cells.

In certain embodiments, the interference that belongs to the neighbor cell may constructed by using the projection operator as shown in Equation 5 below:

P(n,k)=Hᵢ(n,k)(Hᵢ^{T}(n,k)Hᵢ(n,k))⁻¹Hᵢ^{T}(n,k) Equation 5

In certain embodiments, the interference may be subtracted from the total received signal as shown in Equation 6 below:

\tilde{Y}(n,k)=Y(n,k)−Hᵢ(n,k)(Hᵢ^{T}(n,k)Hᵢ(n,k))⁻¹Hᵢ^{T}(n,k)Y(n,k) Equation 6

In certain embodiments, the foregoing procedure may be performed sequentially until all the interference cells whose interfering powers are above a threshold have been subtracted from the total received signal to produce an interference suppressed signal.

In certain embodiments, receiver equalization can be performed on the interference suppressed signal to generate an equalized signal. As an example for an MMSE receiver, equalization can be performed as shown in Equation 7 below:

$${X}_{est} ( n , k ) = {H}_{est}^{H} ( n , k ) {( {H}_{est} ( n , k ) {H}_{est}^{H} ( n , k ) + \frac{1}{SNR} I )}^{- 1} \tilde{Y} ( n , k ) \qquad Equation 7$$

However, if there is a significant error in the estimation of the interference, the foregoing technique could actually degrade rather than improve receiver performance. In certain embodiments, the reliability of the interference estimation and cancellation is directly proportional to the ratio of the interference power over the desired signal power. By using measurements of those parameters, the reliability of the interference suppression algorithm can be significantly enhanced.

To improve the quality of the interference estimation, accurate signal and interference power measurements are needed. To achieve this, different algorithms can be used. However, certain algorithms may bring extra complexity to the receiver in addition to the complexity induced by the interference suppression based receiver. In certain embodiments, available mobility/handover measurements of the mobile network may be used to increase the reliability of the interference suppression techniques without introducing extra complexity.

For example, for UMTS, there are measurement requirements for the MS/UE. These may include power measurements of neighbor Base Stations (BS) by the MS. For example, in a UMTS LTE system, any MS/UE complaint with standards has to perform measurements.

These measurements may include without limitation Reference Signal Received Power (RSRP), Received Signal Strength Indicator (RSSI) and Reference Signal Received Quality (RSRQ).

Any UMTS MS is required to measure RSSI on an ongoing basis. In certain embodiments, each MS may detect up to N cells and measure the RSRP and RSRQ for each of these detected cells. In certain embodiments, N may range from 1 to 10 without limitation. RSRP is the received signal power for each of the BS detected. This power is measured by using the reference signals or pilots transmitted from each neighbor BS. RSSI is the total signal strength at the MS connector including noise and interference from all sources. RSRQ is the scaled ratio of RSRP over RSSI. Therefore, RSRQ is proportional to signal power over signal+interference power. Standards impose strict accuracy requirements on the foregoing measurements; the measurements are therefore considered to be reliable.

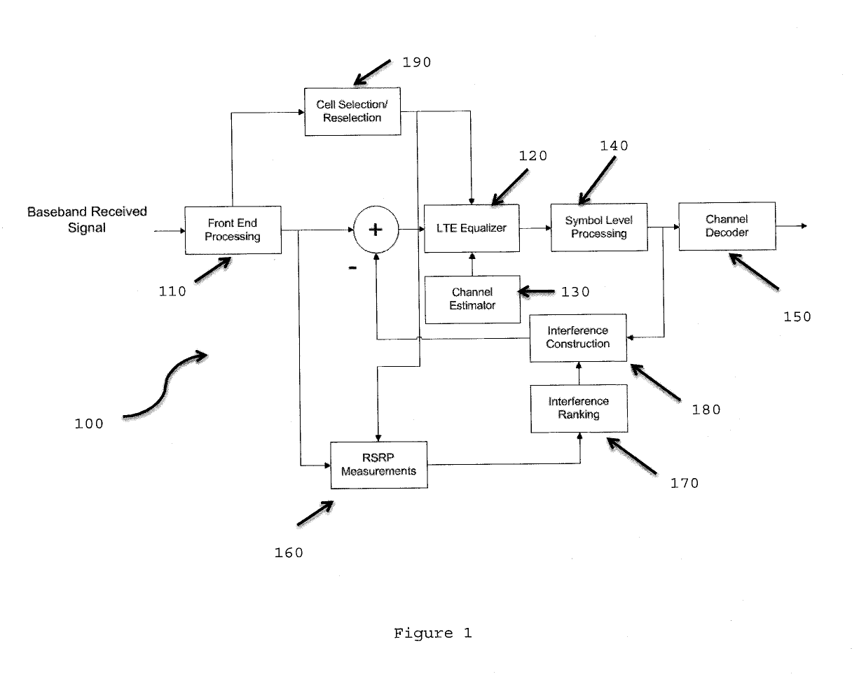

In certain embodiments, as shown in FIG. 1, a UMTS ICT Receiver may be utilized for interference suppression. The receiver may receive a baseband received signal, which may be subjected to front end processing 110 to produce an oversampled broadband signal. After front end processing, the oversampled broadband signal may be sent to an RSRP measurements module 160 for extracting RSRP measurements from pilot signals from neighbor cells. The interference ranking module 170 may be used to rank the neighbor cells from highest RSRP to lowest RSRP.

The interference construction module 180 may be used to generate interference estimates for each of the neighbor cells for which the RSRP exceeds a certain threshold. Those interference estimates may be subtracted from the output of front end processing module 110 to generate an interference suppressed signal that can be equalized in LTE Equalizer 120 to generate an equalized signal. The LTE Equalizer may also receive channel estimates for neighbor cells from Channel Estimator 130. Symbol level processing 140 may be performed on the equalized signal.

The interference construction module may operate in parallel by generating an interference estimate for each neighboring cell with an RSRP above the threshold and then subtracting each of those estimates from the oversampled baseband signal to generate an interference suppressed signal, which then can be equalized by LTE Equalizer 120.

Alternately, the interference construction module may operate in series by generating an interference estimate for the neighbor with the highest RSRP, subtracting that signal from the oversampled baseband signal to generate a first interference suppressed signal, equalizing the first interference suppressed signal to generate a first equalized signal, optionally performing symbol level processing of the first equalized signal, and feeding the result back to the interference construction module 180 so the process can be repeated for the remaining neighbor cells whose RSRP exceeds the threshold.

Once the serial or parallel interference suppression process is complete, the output of the symbol level processing module 140 (or of LTE Equalizer 120 if the optional symbol level processing 140 is not performed) may be provided to Channel Decoder 150 to generate a decoded symbol.

Front end processing module 110 provides input to cell selection/reselection module 190 which may select or reselect a serving cell to which the MS may connect. The cell ID for the selected serving cell may be provided to RSRP Measurements module 160 for use in determining the one or more neighbor cells for which RSRP measurements should be extracted as described above. The Cell ID may also be provided to LTE Equalizer 120 for use in equalizing interference suppressed signals.

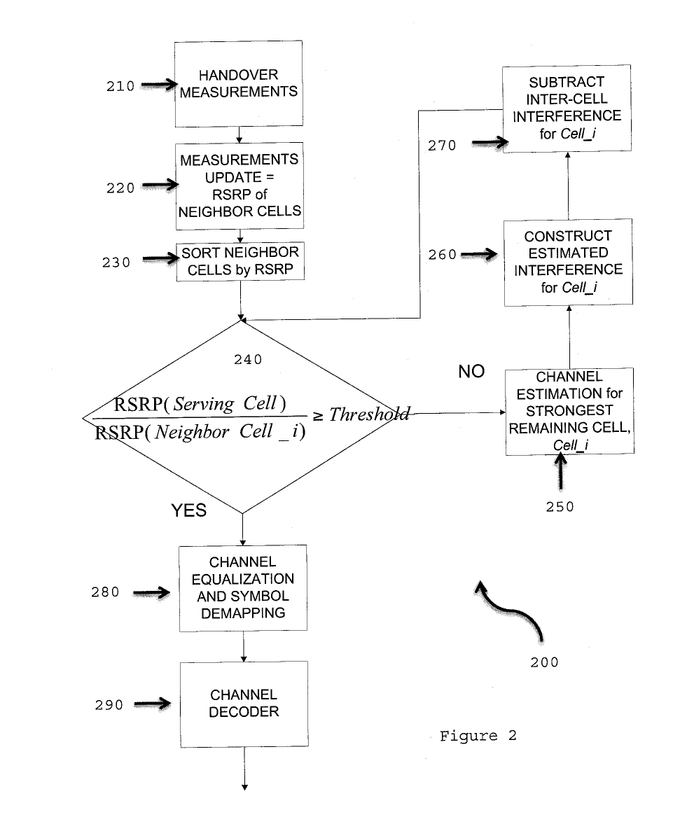

In certain embodiments, as shown in FIG. 2, a method of interference suppression 200 using RSRP measurements may be used. Handover measurements 210 may be received and be used to update measurements 220 by determining an interference power or RSRP for each of one or more neighbor cells. An RSRP may also be determined for a serving cell.

In certain embodiments, neighbor cells may comprise those base stations physically proximate to the serving cell. In certain embodiments, neighbor cells may comprise a list of neighbor cells provided by the serving cell. In certain embodiments, neighbor cells may comprise a measured list of possible cells, which may be based on a search by the MS/UE. In certain embodiments, the serving cell BS may provide a list of neighbor cells which list may be narrowed down by the UE to form a narrowed list of neighbor cells.

In certain embodiments, the neighbor cells may then be sorted by RSRP 230. In certain embodiments, the neighbor cells may be sorted from highest RSRP to lowest RSRP. An RSRP ratio of serving cell RSRP to neighbor cell RSRP may be determined for each neighbor cell. In certain embodiments, a threshold for RSRP ratio may be determined, below which the interference from the particular neighbor cell is significant. The threshold may be predetermined or may be obtained experimentally. In certain embodiments, adaptive thresholding techniques may be used in a MS/UE to determine the threshold. Adapting thresholding parameter can be selected from a look up table of threshold parameter values vs. either the measured RSSP or measured RSSI of the serving cell as explained before. With this approach, the possibility of destructive interference suppression may be significantly reduced.

In certain embodiments, the neighbor cells may be processed from highest to lowest RSRP. For neighbor cells i to n, the RSRP ratio for the i^{th} neighbor cell may be compared to the threshold 240. If the RSRP ratio of the i^{th} neighbor cell is not greater than or equal to the threshold, a channel estimate for the i^{th} cell may be generated 250, an interference estimate may be constructed for the i^{th} cell 260 and the interference estimate may be subtracted 270 from the total received signal to generate an i^{th} interference suppressed signal. The channel estimation 250, interference estimation 260 and subtraction 270 loop may be repeated on the i^{th} interference suppressed signal for each of neighbor cells i+1 to n until a neighbor cell is reached for which the RSRP ratio is greater than or equal to the threshold.

Once the iteration is reached for which the RSRP ratio is greater than or equal to the threshold, channel equalization and symbol demapping 280 may be performed on the interference suppressed signal, which then may be decoded 290 by a channel decoder.

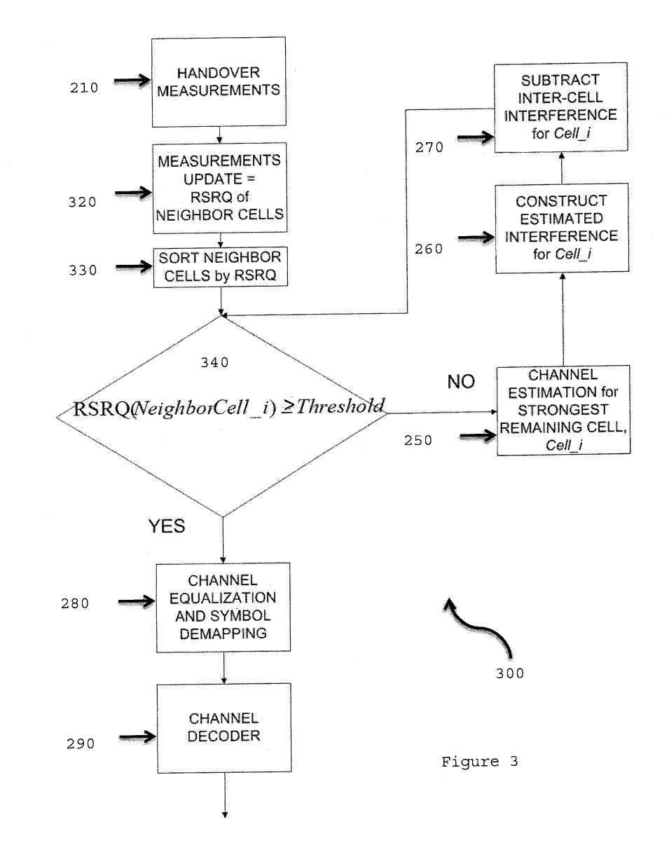

In certain embodiments, as shown in FIG. 3, a method of interference suppression 300 using RSRQ measurements may be used. Handover measurements 210 may be received and be used to update measurements 320 by determining an interference power or RSRQ for each of one or more neighbor cells.

In certain embodiments, neighbor cells may comprise those base stations physically proximate to the serving cell. In certain embodiments, neighbor cells may comprise a list of neighbor cells provided by the serving cell. In certain embodiments, neighbor cells may comprise a measured list of possible cells, which may be based on a search by the MS/UE. In certain embodiments, the serving cell BS may provide a list of neighbor cells which list may be narrowed down by the UE to form a narrowed list of neighbor cells.

In certain embodiments, the neighbor cells may then be sorted by RSRQ 330. In certain embodiments, the neighbor cells may be sorted from lowest RSRQ to highest RSRQ. In certain embodiments, a threshold for RSRQ may be determined, below which the interference from the particular neighbor cell is significant. The threshold may be predetermined or may be obtained experimentally. For RSRQ, thresholds above −0.3 dB provide acceptable results in certain cases. In certain embodiments, adaptive thresholding techniques may be used in a MS/UE to determine the threshold as explained before. With this approach the possibility of destructive interference suppression may be significantly reduced.

In certain embodiments, the neighbor cells may be processed from lowest to highest RSRQ. For neighbor cells i to n, the RSRQ for the i^{th} neighbor cell may be compared to the threshold 340. If the RSRQ of the i^{th} neighbor cell is not greater than or equal to the threshold, a channel estimate for the i^{th} cell may be generated 250, an interference estimate may be generated for the i^{th} cell 260 and the interference estimate may be subtracted 270 from the total received signal to generate an i^{th} interference suppressed signal. The channel estimation 250, interference estimation 260 and subtraction 270 loop may be repeated on the i^{th} interference suppressed signal for each of neighbor cells i+1 to n until a neighbor cell is reached for which the RSRQ is less than or equal to the threshold.

Once the iteration is reached for which the RSRQ is greater than or equal to the threshold, channel equalization and symbol demapping 280 may be performed on the interference suppressed signal, which then may be decoded 290 by a channel decoder.

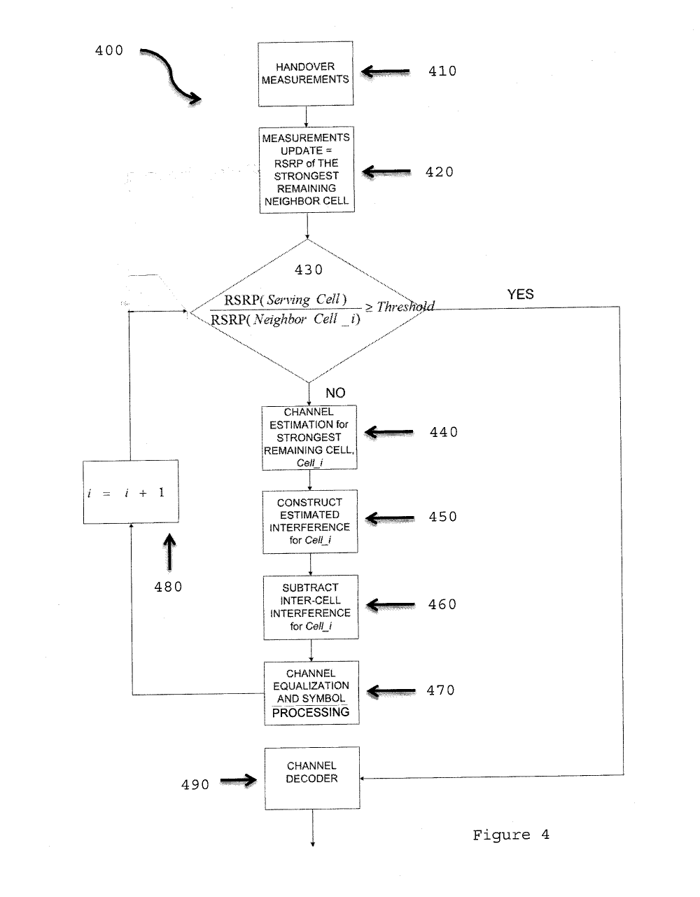

In certain embodiments, as shown in FIG. 4, a method of interference suppression 400 using RSRP measurements may be used. Handover measurements 410 may be received and be used to update measurements 420 by determining the interference power or RSRP for the strongest remaining one neighbor cell. An RSRP may also be determined for a serving cell.

In certain embodiments, neighbor cells may comprise those base stations physically proximate to the serving cell. In certain embodiments, neighbor cells may comprise a list of neighbor cells provided by the serving cell. In certain embodiments, neighbor cells may comprise a measured list of possible cells, which may be based on a search by the MS/UE. In certain embodiments, the serving cell BS may provide a list of neighbor cells which list may be narrowed down by the UE to form a narrowed list of neighbor cells.

The RSRP ratio of serving cell RSRP to strongest remaining neighbor cell RSRP may be determined. In certain embodiments, a threshold for RSRP ratio may be determined, below which the interference from the particular neighbor cell is significant. The threshold may be predetermined or may be obtained experimentally. In certain embodiments, adaptive thresholding techniques may be used in a mobile device or user equipment (UE) to determine the threshold as explained before. With this approach the possibility of destructive interference suppression may be significantly reduced.

In certain embodiments, the RSRP ratio for the i^{th} neighbor cell, which is the strongest remaining neighbor cell as determined at step 420, may be compared to the threshold 430. If the RSRP ratio of the i^{th} neighbor cell is not greater than or equal to the threshold, a channel estimate for the i^{th} cell may be generated 440, an interference estimate may be generated for the i^{th} cell 450 and the interference estimate may be subtracted 460 from the total received signal to generate an i^{th} interference suppressed signal. Channel equalization and symbol demapping 470 may be performed on the i^{th} interference suppressed signal. The value of i may be incremented 480 and the process returned to step 420. The loop including measurements update 420, comparison 430, channel estimation 440, interference estimation 450, subtraction 460, equalization 470, and incrementing 480 may be repeated until a neighbor cell is reached for which the RSRP ratio is greater than or equal to the threshold.

Once the iteration is reached for which the RSRP ratio is greater than or equal to the threshold, the remaining interference suppressed signal may be decoded 490 by a channel decoder.

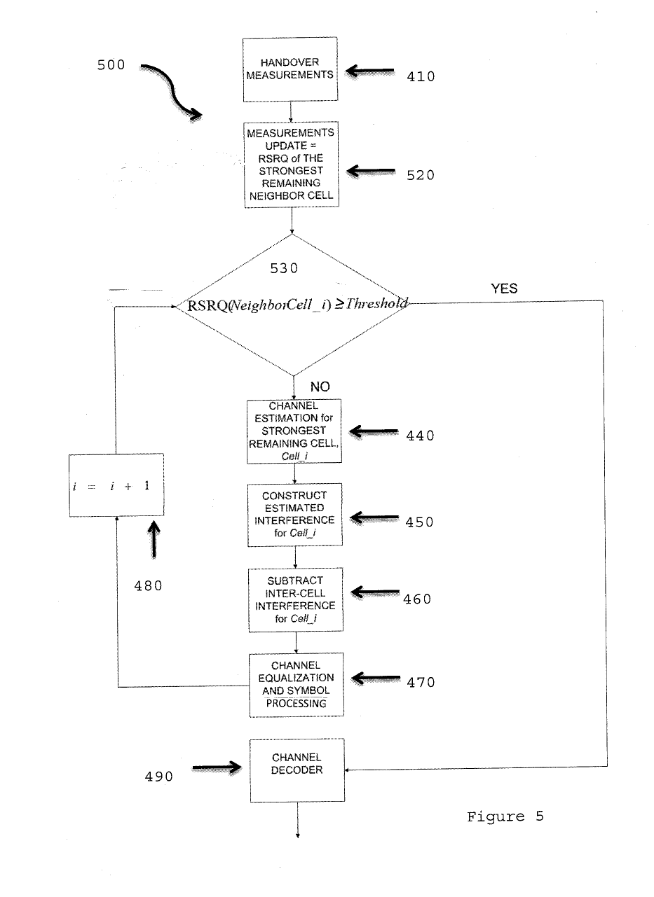

In certain embodiments, as shown in FIG. 5, a method of interference suppression 500 using RSRQ measurements may be used. Handover measurements 410 may be received and be used to update measurements 520 by determining the interference power or RSRQ for the strongest remaining one neighbor cell.

In certain embodiments, neighbor cells may comprise those base stations physically proximate to the serving cell. In certain embodiments, neighbor cells may comprise a list of neighbor cells provided by the serving cell. In certain embodiments, neighbor cells may comprise a measured list of possible cells, which may be based on a search by the MS/UE. In certain embodiments, the serving cell BS may provide a list of neighbor cells which list may be narrowed down by the UE to form a narrowed list of neighbor cells.

The RSRQ of the strongest remaining neighbor cell may be determined. In certain embodiments, a threshold for RSRQ may be determined, below which the interference from the particular neighbor cell is significant. The threshold may be predetermined or may be obtained experimentally. For RSRQ, thresholds above −0.3 dB provide acceptable results in certain cases. In certain embodiments, adaptive thresholding techniques may be used in a mobile device or user equipment (UE) to determine the threshold as explained before. With this approach the possibility of destructive interference suppression may be significantly reduced.

In certain embodiments, the RSRQ for the i^{th} neighbor cell, which is the strongest remaining neighbor cell as determined at step 520, may be compared to the threshold 530. If the RSRQ of the i^{th} neighbor cell is not greater than or equal to the threshold, a channel estimate for the i^{th} cell may be generated 440, an interference estimate may be generated for the i^{th} cell 450 and the interference estimate may be subtracted 460 from the total received signal to generate an i^{th} interference suppressed signal. Channel equalization and symbol demapping 470 may be performed on the interference suppressed signal. The value of i may be incremented 480 and the process returned to step 520. The measurements update 520, comparison 530, channel estimation 440, interference estimation 450, subtraction 460, equalization 470, and incrementing 480 loop may be repeated until a neighbor cell is reached for which the RSRQ is less than or equal to the threshold.

Once the iteration is reached for which the RSRQ is greater than or equal to the threshold, the remaining interference suppressed signal may be decoded 490 by a channel decoder.

While the above description contains many specifics, these should not be construed as limitations on the scope of the invention, but rather as an exemplification of preferred embodiments thereof. The invention includes any combination or subcombination of the elements from the different species and/or embodiments disclosed herein. One skilled in the art will recognize that these features, and thus the scope of the present invention, should be interpreted in light of the following claims and any equivalents thereto.

We claim:

1. A method for suppressing interference comprising:
determining a signal power of a serving cell;
determining an interference power of each of one or more neighbor cells;
constructing an interference estimate for one or more of the neighbor cells;
subtracting each of the interference estimates from a total received signal to generate an interference suppressed signal.

2. The method of claim 1, wherein the step of constructing an interference estimate is performed for each of the neighbor cells for which the ratio of signal power to interference power is greater than the threshold.

3. The method of claim 1, wherein the step of constructing an interference estimate is performed for each of the neighbor cells for which the ratio of signal power to interference power is less than the threshold.

4. The method of claim 1, further comprising equalizing the interference suppressed signal to generate an equalized signal.

5. The method of claim 2, further comprising decoding the equalized signal to generate a decoded symbol.

6. The method of claim 1, further comprising sorting the neighbor cells from highest interference power to lowest interference power.

7. The method of claim 4, wherein subtracting comprises subtracting each of the interference estimates in order from highest interference power to lowest interference power.

8. The method of claim 3, wherein the signal power equals the Reference Signal Received Power for the serving cell.

9. The method of claim 6, wherein the interference power of each neighbor cell equals the Reference Signal Received Power for the neighbor cell.

10. The method of claim 1, wherein constructing an interference estimate comprises constructing an interference estimate at least in part from a pilot signal for each of the neighbor cells for which the signal to interference ratio is less than the threshold.

11. The method of claim 2, wherein the interference power of each neighbor cell equals the Reference Signal Received Quality for the neighbor cell.

12. A method for suppressing interference comprising:
determining a Received Signal Received Power (RSRP) for each of n neighbor cells to a serving cell;
sorting the RSRP for each of the n neighbor cells from a first largest RSRP to an nth smallest RSRP;
setting an interference suppressed signal equal to the total received signal;
for i=1 to n:
determining an i^{th} RSRP ratio of a serving cell RSRP to the i^{th} RSRP;
comparing the i^{th} RSRP ratio to a threshold;
if the i^{th} RSRP ratio is less than the threshold:
constructing a i^{th} interference estimate for the i^{th} neighbor cell;
subtracting the i^{th} interference estimate from the interference suppressed signal to generate an i^{th} interference suppressed signal;
setting the interference suppressed signal equal to the i^{th} interference suppressed signal; and
incrementing i; and
if the i^{th} RSRP ratio is greater than or equal to the threshold:
equalizing the interference suppressed signal to form an equalized signal; and
decoding the equalized signal to form a decoded signal.

13. The method of claim 13, wherein the i^{th} RSRP is determined at least in part from the pilot signal for the i^{th} neighbor cell.

14. A method for suppressing interference comprising:
determining an Received Signal Received Quality (RSRQ) for each of n neighbor cells to a serving cell;
sorting the RSRQ for each of the n neighbor cells from a first largest RSRQ to an nth smallest RSRQ;
setting an interference suppressed signal equal to the total received signal;
for i=1 to n:
comparing the i^{th} RSRQ to a threshold;
if the i^{th} RSRQ is greater than the threshold:
constructing a i^{th} interference estimate for the i^{th} neighbor cell;
subtracting the i^{th} interference estimate from the interference suppressed signal to generate an i^{th} interference suppressed signal;
setting the interference suppressed signal equal to the i^{th} interference suppressed signal; and
incrementing i; and
if the i^{th} RSRQ is less than or equal to the threshold:
equalizing the interference suppressed signal to form an equalized signal; and
decoding the equalized signal to form a decoded signal.

15. The method of claim 15, wherein the i^{th} RSRQ is determined at least in part from the pilot signal for the i^{th} neighbor cell.

16. A interference suppressor comprising:
a receiver for receiving a total received signal and one or more signals from one or more neighbor cells;
a channel estimator for generating channel estimates for the one or more neighbor cells;
a power measurement unit for estimating powers of the one or more neighbor cells;
a comparator for comparing each of the powers from the one or more neighbor cells with a threshold;
an interference estimator for generating interference estimates for neighbor cells whose power exceeds the threshold;
an interference suppressor for subtracting the interference estimates from the total received signal to generate an interference suppressed signal.

17. The interference suppressor of claim 20, further comprising a channel equalizer for equalizing the interference suppressed signal to generate an equalized signal.

18. The interference suppressor of claim 21, further comprising a channel decoder for decoding the equalized signal to form a decoded signal.
